(19) United States
(12) Patent Application Publication
(10) Pub. No.: US 2018/0276540 A1
(43) Pub. Date: Sep. 27, 2018

(54) MODELING OF THE LATENT EMBEDDING OF MUSIC USING DEEP NEURAL NETWORK

(71) Applicant: NextEV USA, Inc., San Jose, CA (US)

(72) Inventor: Zhou Xing, San Jose, CA (US)

(21) Appl. No.: 15/466,533

(22) Filed: Mar. 22, 2017

(51) Int. Cl. G06N 3/08; G10H 1/00; G06N 3/04

(52) U.S. Cl. CPC G06N 3/08; G10H 1/0008; G06N 3/04; G10H 2240/081; G10H 2250/311; G10H 2240/075; G10H 2250/215

(57) ABSTRACT

Methods and systems are provided for detecting and cataloging qualities in music. While both the data volume and heterogeneity of the digital music content is huge, it has become increasingly important and convenient to build a recommendation or search system to facilitate surfacing these content to the user or consumer community. Embodiments use deep convolutional neural network to imitate how human brain processes hierarchical structures in the auditory signals, such as music, speech, etc., at various timescales. This approach can be used to discover the latent factor models of the music based upon acoustic hyper-images that are extracted from the raw audio waves of music. These latent embeddings can be used either as features to feed to subsequent models, such as collaborative filtering, or to build similarity metrics between songs, or to classify music based on the labels for training such as genre, mood, sentiment, etc.

### FIELD

The present disclosure is generally directed to using convolutional neural networks to process music, in particular toward discovering latent embeddings in music based on hyper-images extracted from raw audio waves.

### BACKGROUND

As network bandwidth, cloud-based storage, and hard-drive storage sizes have increased over time, the access of users of personal computing devices such as smartphones, tablets and laptops has likewise increased. While persons seeking to listen to music were, in the past, limited in choice to music in their own personal library, today's listeners have access to a seemingly unlimited number of songs at their fingertips. Currently services such as Tidal, Spotify, Apple Music, and Amazon Music provide users with a huge and ever-growing music library. As a result, users are left with an increasingly complex selection of music. This has created a need for an efficient music recommendation system. Moreover, given the huge number of songs created and added to music-streaming service every day, an automated system of analyzing music, creating playlists, and fulfilling recommendation requests based on that analysis is needed.

While both the data volume and heterogeneity in the digital music market is huge, it has become increasingly important and convenient to build automated systems of recommendation and search in order to facilitate the users to locate as well as discover the relevant content. For recommendation systems, most of the models are formulated following the concept of collaborative filtering and content based methodologies. While collaborative filtering model requires substantial user feedback signals to learn or capture the user-content latent embedding, it is difficult to precisely model the latent space in a “cold start” scenario when there is little signal collected from the users. Conventional content-based approaches try to solve this problem using explicit features associated with music, but limitation resides in the diversity and the level of fineness of recommendations.

Traditionally, music recommendation systems have been created mostly relying on collaborative filtering approaches. Collaborative filtering is a method of generating automatic predictions about the interests of a user based on historical data collected from the listening habits of many users. Collaborative filtering relies on an assumption that if a first person has the same opinion as a second person on a first issue, the two are more likely to agree on a second issue than the first person and a randomly selected person. At least one issue with collaborative filtering is that unless the platform implementing the collaborative filtering method achieves unusually good diversity and independence of opinion, the collaborative filtering method would lean heavily on a biased opinion and would recommend more generic and widely-liked media as opposed to lesser-known and less-liked media. Moreover, methods of collaborative filtering require and rely upon a huge amount of historical data, resulting in a recommendation system that is incapable of recommending brand-new media. When new media is added to a source library, a number of users must manually rate the media before the new media can be recommended to any user by the collaborative filtering system. Collaborative filtering typically results in the “cold start” problem. New users are required to rate a sufficient number of media items to enable the system to capture their preferences accurately and to be enabled to provide reliable recommendations.

Music, as well as speech, is a complex auditory signal that contains structures at multiple timescales. Neuroscience studies have shown that the human brain integrates these complex streams of audio information through various levels of voxel, auditory cortex (A1+), superior temporal gyms (STG), and inferior frontal gyms (IFG), etc. The temporal structure of the auditory signals can be well recognized by the neural network in human brain. The human brain cannot, however, analyze large amounts of music simultaneously and with the same level of accuracy as required for the amount of music being released daily.

Today, most of the recommendation models fall into two primary species, collaborative filtering based and content based approaches. Variants of instantiations of collaborative filtering approach suffer from the common issues of so called “cold start” and “long tail” problems where there is not much user interaction data to reveal user opinions or affinities on the content and also the distortion towards the popular content. Content-based approaches are sometimes limited by the richness of the available content data resulting in a heavily biased and coarse recommendation result.

### BRIEF DESCRIPTION OF THE DRAWINGS

FIG. 1 is a block diagram of a computer network environment implementing a latent embedding detection and music recommendation system according to one embodiment.

FIG. 2 is a block diagram of a computing environment for training and testing a music recommendation system in accordance with one embodiment.

FIG. 3 is a block diagram of a computing environment for training and testing a music recommendation system in accordance with one embodiment.

FIG. 4A is an illustration of a sound wave of a song snippet in accordance with an embodiment of the disclosure.

FIG. 4B is an illustration of a number of transformations of a sound wave of a song snippet in accordance with an embodiment of the disclosure.

FIG. 4C is an illustration of a transformation of a sound wave of a song snippet in accordance with an embodiment of the disclosure.

FIG. 4D is an illustration of a transformation of a sound wave of a song snippet in accordance with an embodiment of the disclosure.

FIG. 4E is an illustration of a transformation of a sound wave of a song snippet in accordance with an embodiment of the disclosure.

FIG. 4F is an illustration of a transformation of a sound wave of a song snippet in accordance with an embodiment of the disclosure.

FIG. 4G is an illustration of a transformation of a sound wave of a song snippet in accordance with an embodiment of the disclosure.

FIG. 5A is an illustration of a hyper-image of a song snippet in accordance with an embodiment of the disclosure.

FIG. 5B is an illustration of a hyper-image of a song snippet in accordance with an embodiment of the disclosure.

FIG. 6 is a block diagram of a computing environment for training a music recommendation system in accordance with one embodiment.

FIG. 7A is an illustration of a song database in accordance with one embodiment.

FIG. 7B is an illustration of a song database in accordance with one embodiment.

FIG. 8 is an illustration of a convolutional neural network in accordance with an embodiment of the disclosure.

FIG. 9A is an illustration of a table of results in accordance with an embodiment of the disclosure.

FIG. 9B is an illustration of song analysis results in accordance with an embodiment of the disclosure.

FIG. 10 is a flow chart illustrating a method for training a convolutional network in accordance with one embodiment.

FIG. 11 is a flow chart illustrating an exemplary method in accordance with one embodiment.

FIG. 12 is a flow chart illustrating an exemplary method in accordance with one embodiment.

### DETAILED DESCRIPTION

Embodiments of the present disclosure relate to providing music analysis and recommendation methods and systems using convolutional neural networks. In certain embodiments, a convolutional neural network (CNN) is implemented and trained to analyze music and learn to detect features, thus enabling a computer program to automatically identify song features and classify music based on identified features. For example, embodiments of the present disclosure provide methods and systems for automatically identifying characteristics of music such as genre, emotion, tempo range, featured instruments, etc. using a trained CNN. In certain embodiments, an image representation of a snippet or sample of a song, known as a “hyper-image” may be generated and used as an input to a CNN. Using a CNN, one or more features of the song may be detected automatically and the song may be automatically tagged or categorized by such features. Using this process, a database of tagged songs may be automatically populated.

CNNs have been used to automatically identify patterns or features in a number of images and to use identified patterns and features to categorize the images based on the existence of patterns and features in each image. Disclosed herein are embodiments in which a CNN may be trained to identify both explicit features (e.g., genre, type, rhythm, pitch, loudness, timbre, etc.) and latent features (e.g., mood, sentiment, etc.) in a song and to automatically classify the song into a number of categories.

Deep neural networks or CNNs have been shown to successfully perform image classification and recognition. Localized convolutions to three-dimensional (3D) neurons have been able to capture latent features as well as other explicit features on images such as patterns, colors, brightness, etc. Every entry in the 3D output volume, axon, can also be interpreted as an output of a neuron that picks up stimulus from a small region in the input, and that information is shared with all neurons spatially in the same layer. All these dendrite signals, through synapse, may be integrated together to the other axon.

Disclosed herein are methods and systems using a deep convolutional neural network (CNN) to learn latent models of music based upon acoustic data. A rationale behind such an approach is that most explicit features associated with music, such as genre, type, rhythm, pitch, loudness, timbre, etc. as well as latent features, for example mood, sentiment of the song, etc. may be revealed using various filters in a neural network. Such latent embeddings of songs can be used either as features to feed to subsequent recommendation models, such as collaborative filtering, to alleviate the issues with such models mentioned above, or to build similarity metrics between songs, or simply to classify music into targeted training classes such as genre, mood, etc. The deep learning model may in some embodiments be executed using CUDA® computation framework using NVIDIA® GTX-1080 GPU infrastructures.

Embodiments of the present disclosure will be described in connection with a music analysis system comprising a CNN. A description of example embodiments of the disclosure follows.

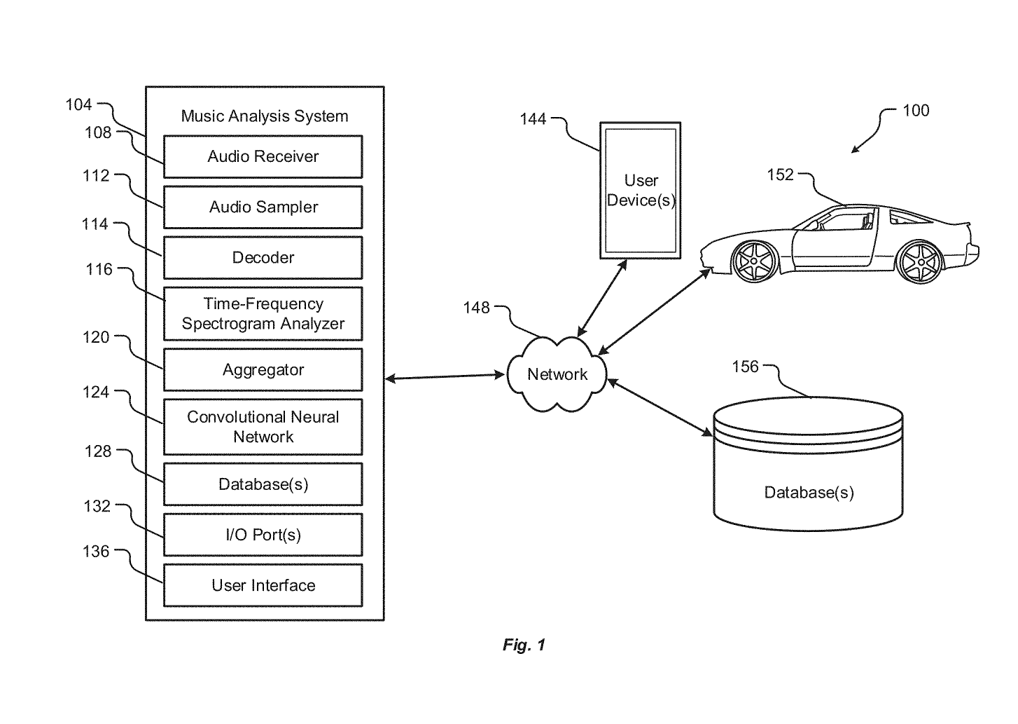

Referring to FIG. 1, an overview of an environment 100 of an embodiment utilizing a music analysis system 104 is illustrated. In certain embodiments, the music analysis system 104 may be a server, PC, smartphone, tablet, or other computing device. A music analysis system 104 may comprise of one or more of an audio receiver 108, an audio sampler 112, a decoder 114, a time-frequency spectrogram analyzer 116, an aggregator 120, a convolutional neural network (CNN) 124, one or more databases 128, one or more input and/or output ports 132, and/or a user interface 136. The function and use of these components of the music analysis system 104 will be described in detail below. At least one I/O port 132 of the music analysis system 104 may be a network communication module configured to interact with a network 148. Via the network 148, the music analysis system 104 may be operable to communicate with one or more user devices 144, one or more vehicle systems 152, e.g. a vehicle with onboard network-connected computer, and/or one or more databases 156.

Audio receiver 108 may operate to receive audio in a number of ways. In some embodiments, the audio receiver 108 may be a function performed by a processor of the music analysis system 104 and may receive audio by accessing audio files sent via the network 148. In some embodiments, the audio receiver 108 may be a microphone and/or DAC capable of capturing and/or receiving audio waves and converting audio waves to digital files.

Digital audio files received by the audio receiver 108 may be accessed by an audio sampler 112. The audio sampler 112 may be a function of one or more processors. The audio sampler 112 may access or retrieve one or more audio files, for example one received via the audio receiver 108. The audio sampler 112 may generate a new, shortened audio file or snippet comprising of a portion of the received audio file. For example, a snippet may be a three second sound clip taken from the middle of the audio file. In other embodiments, the snippet may be shorter or longer than three seconds and may be taken from any portion of a received audio file. The audio sampler 112 may receive an audio file of any length and output a snippet version audio file of any length.

A decoder 114 may retrieve a snippet audio file as generated by an audio sampler 112 and may convert or decode the audio file into a visual waveform image. The decoder 114 may be a function of one or more processors of the music analysis system 104.

A time-frequency spectrogram analyzer 116 may receive the snippet and/or decoded waveform image and perform one or more transformations. For example, the time-frequency spectrogram analyzer 116 may generate a spectrogram, a spectral centroid calculation, a melodic range spectrogram, shift-invariant latent variable (silvet) note transcription, cepstral pitch analysis, constant-Q, an onset likelihood curve, or any other visual representation of the snippet.

Any of the visual representations of audio files may be an image of a graph in the time domain and measured in, for example, frequency in Hz, musical-notes, frequency bins, etc. The graphs may be displayed in a linear scale or logarithmic scale. The images may comprise frequencies shown on a vertical axis and time on a horizontal axis or vice-versa. Lower frequencies may represent lower tone notes in music. A third dimension may be shown in the images using an intensity of color and may represent an amplitude of a particular frequency at a particular time. The frequency and amplitude axes may be in either linear or logarithmic scale. Logarithmic amplitude axes may be used to represent audio in dB and may emphasize musical, tonal relationships while frequency may be measured linearly in Hz or musical notes to emphasize harmonic relationships.

In certain embodiments, the visual representation may be a spectrogram or an acoustical spectra analysis at audio frequencies of a snippet of audio. Such analysis may be performed by one or more processors of a computer system including a sound card with appropriate software. Spectrograms may be created using a filterbank resulting from a series of band-pass filters to approximate the spectrogram or be created using a Fourier transform of the audio signal.

In certain embodiments, a chromagram may be generated. Chromagrams may be useful in identifying pitches and illustrating variations in timbre and harmony. Chromagrams may be generated by using a short-time Fourier transform in combination with binning strategies to identify notes.

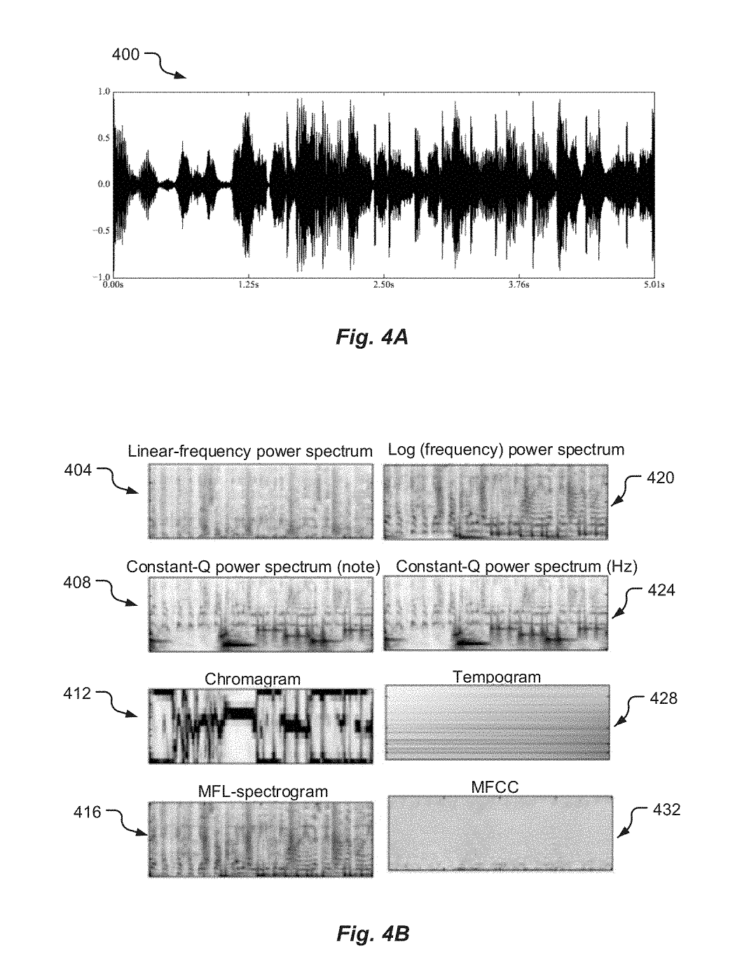

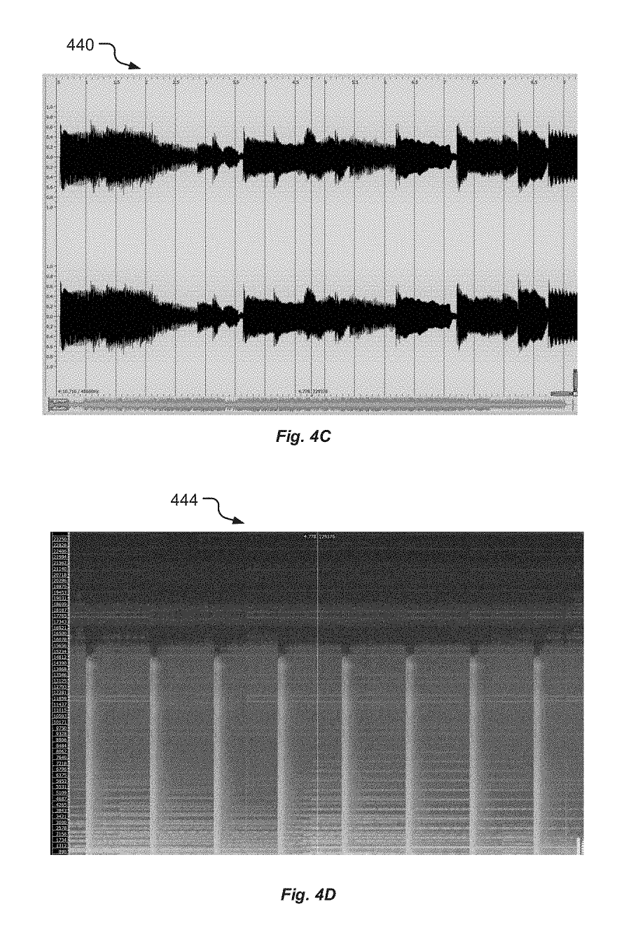

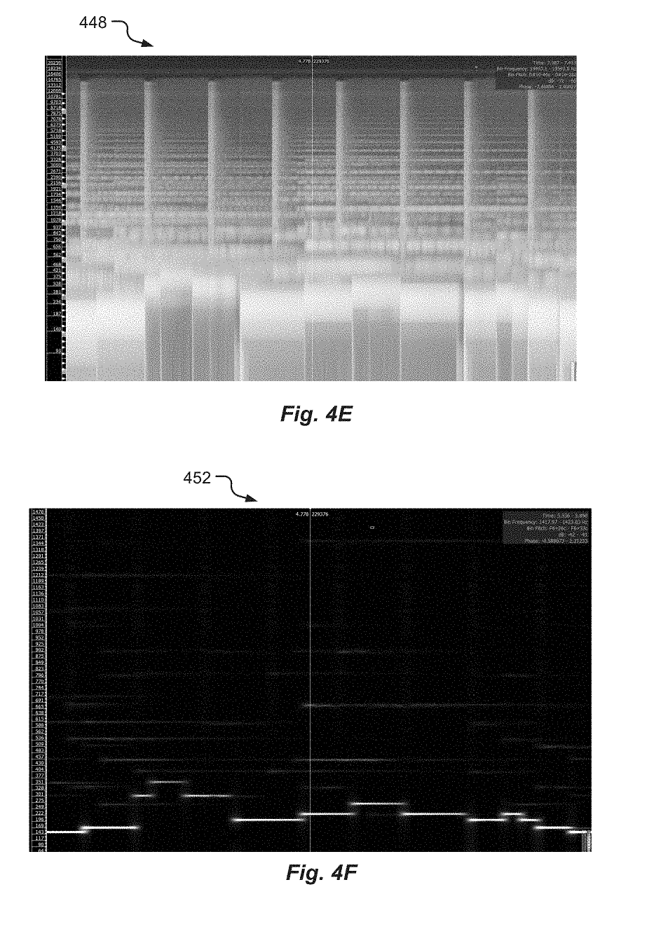

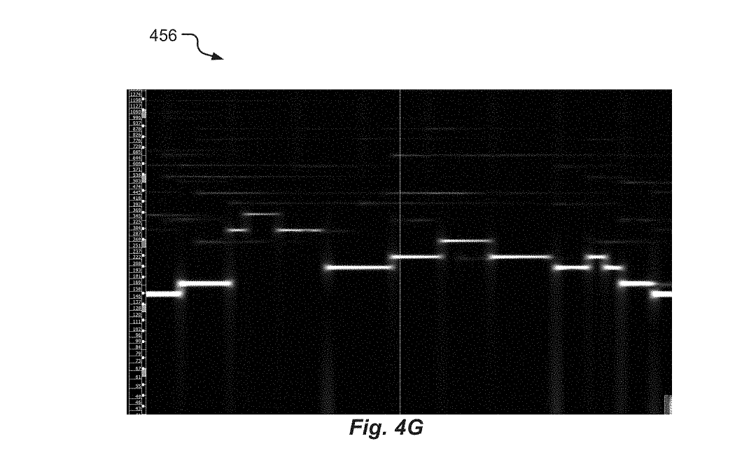

In some embodiments, other time-frequency analysis may be used as known in the art. For example, spectral centroid calculations, melodic range spectrograms, silvet note transcription, cepstral pitch analysis, constant-Q power spectrum, onset likelihood curves, tempograms, mel-Frequency Analysis, and/or mel-frequency cepstrum (MFC) or mel-frequency cepstral coefficients analysis (MFCC). Such image representations may be as illustrated in FIG. 4B.

The time-frequency spectrogram analyzer 116, which may accept audio snippet files as input, may output a number of visual representatives of the input or one or more image files. The aggregator 120 may take as input the one or more image files output by the time-frequency spectrogram analyzer 116 and output a hybrid-image. The aggregator 120 may operate to digitally stitch the input image files to create a composite image file or hybrid-image. The time-frequency spectrogram analyzer 116 may be a function performed by one or more processors of the music analysis system 104.

The CNN 124 may accept a hybrid image and process the hybrid image as discussed in further detail below. After processing the hybrid image, the CNN 124 may output a score vector. The score vector may be stored along with any associated song data in one or more databases 128 stored in memory.

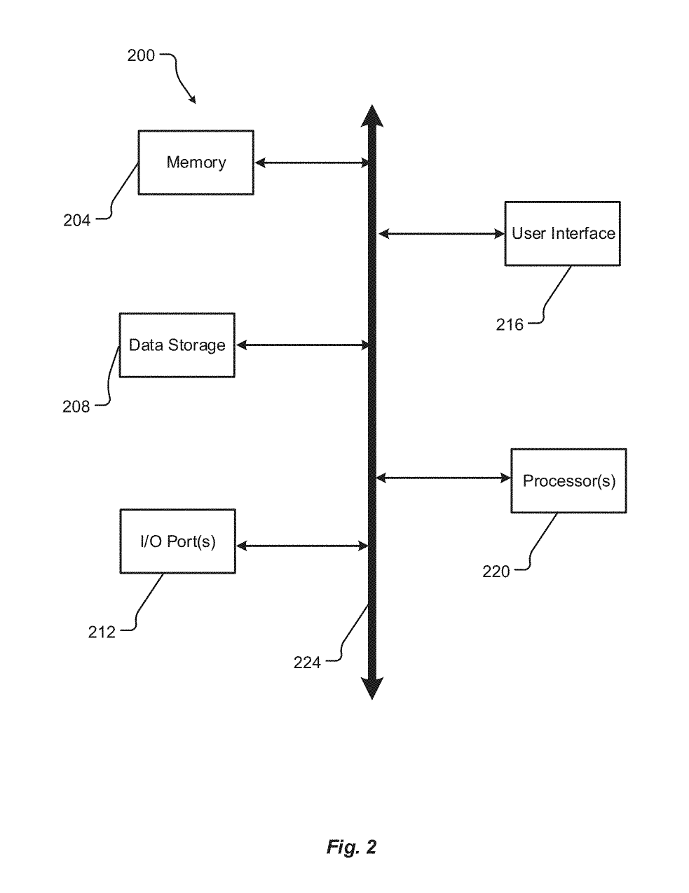

An exemplary computing device 200 is illustrated in FIG. 2 which may in some embodiments be used to implement the music analysis system 104 described herein. It should be understood that the arrangement and description set forth is only an example and that other arrangements and other elements may be used in addition to or instead of the elements shown. Moreover, the computing device 200 may be implemented without one or more of the elements shown in the figure. The music analysis system 104 may be implemented using any computing device, such as a smartphone, laptop, tablet, personal-computer, server, etc. As illustrated in FIG. 2, a computing device 200 may comprise memory device(s) 204, data storage device(s) 208, I/O port(s) 212, a user interface 216, and one or more processors 220. The components as illustrated in FIG. 2 may communicate via a bus 224.

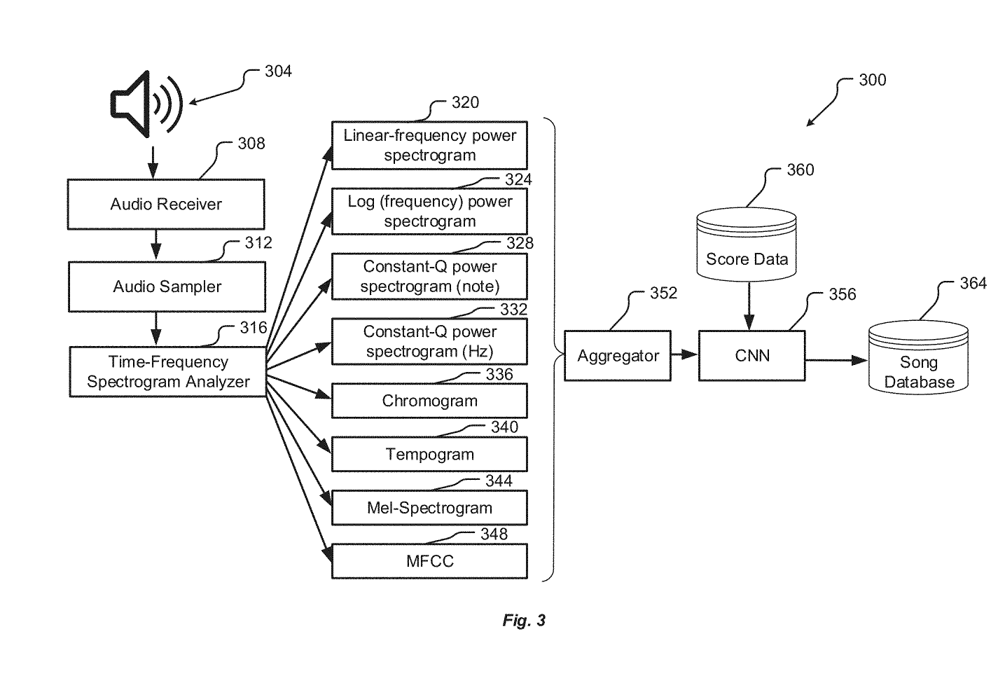

Referring now to FIG. 3, a block diagram is provided illustrating an exemplary music analysis system 300 in accordance with one or more embodiments. In some embodiments, the music analysis system 104 may receive audio 304 via an audio receiver 308. The audio received may be in the form of a digital file (e.g., mp3, way, etc.) with or without metadata or tags providing identifying information such as artist, title, album, genre, year, song emotion, song key, etc. In some embodiments, the music analysis system 300 may receive audio 304 via a microphone or other audio reception device. Audio may also be received digitally via a network.

In some embodiments, received audio may be sampled by an audio sampler device 312. For example, a snippet of a song may be captured to be used by the CNN 356 for analysis. A snippet may be a clip of the received song and may be any length of time, e.g. between 1-5 seconds. In some embodiments, an entire song may be analyzed by the CNN 356.

After audio is received by the music analysis system 300 and following, in some embodiments, the sampling of the audio, the received audio and/or sample may be decoded into a sound wave image file for transformation and analysis purposes by a decoder. An example sound wave for a song snippet 400 is illustrated in FIG. 4A. In FIG. 4A, a five-second snippet of an extracted sound wave signal 400 for the song “My Humps” by “Black Eyed Peas” is illustrated. A tool such as FFmpeg™ may be used to decode audio files such as mp3 into waveform files thus generating time series data of the sound wave.

A time frequency spectrogram analyzer 316 may be used to create a number of time frequency representations. For example, the sample sound wave may be processed by the time-frequency spectrogram analyzer 316 to generate one or more of a linear-frequency power spectrogram, a log frequency power spectrogram, a constant-Q power spectrogram (note), a constant-Q power spectrogram (Hz), a chromo-gram, a tempogram, a mel-spectrogram, and/or an MFCC or other transformations as known in the art. Such representations may be as illustrated in FIG. 4B.

As illustrated in FIG. 4B, subsequent feature engineering of the audio file may involve generating visual representations of the sound wave 400. Fourier transform or other methods of transformation may be used to generate a linear-frequency power spectrum 404 and/or a log-frequency power spectrum 420 from the input wave signal 400 in some embodiments. Constant Q-transform (CQT) may be used to generate power spectrums of the sound in both the chromatic scale (musical note) domain 408 and in frequency (Hz) 424. A Chroma-gram 412 of the 12 pitch classes may also be constructed using short-time Fourier transforms in combination with binning strategies. An extraction of the local tempo and beat information may be implemented using a mid-level representation of cyclic tempograms 428, where tempi differing by a power of two may be identified.

Perceptual scale of pitches such as melody spectrogram (MEL-spectrogram) 416 and mel-frequency cepstrum consisting of various Mel-frequency cepstral coefficients (MFCC) 432 may be generated by taking a discrete cosine transformation of the mel logarithmic powers.

A two channel waveform 440 may be generated as illustrated in FIG. 4C. Additionally, or alternatively, a spectrogram in the linear scale 444 as illustrated in FIG. 4D, a spectrogram on the log scale 448 as illustrated in FIG. 4E, a melodic range linear analysis 452 as illustrated in FIG. 4F, and or a melodic range analysis on the linear scale as illustrated in FIG. 4G may be generated in certain embodiments.

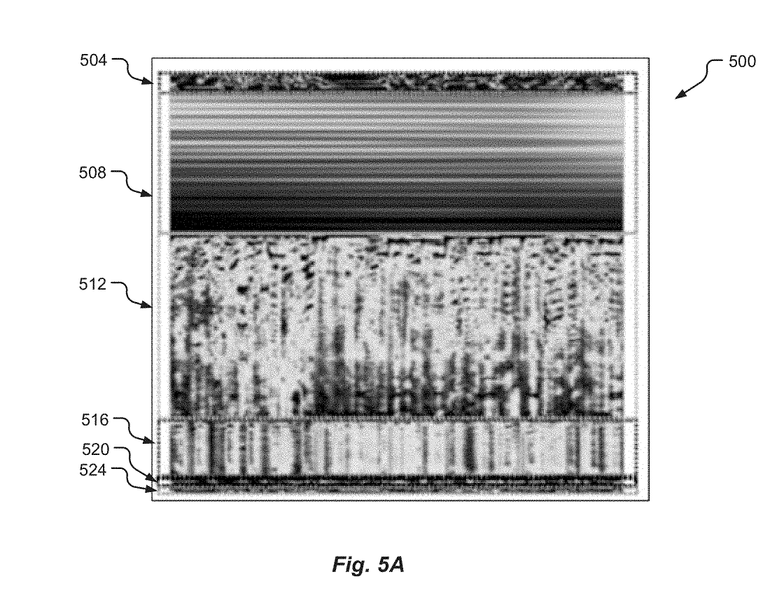

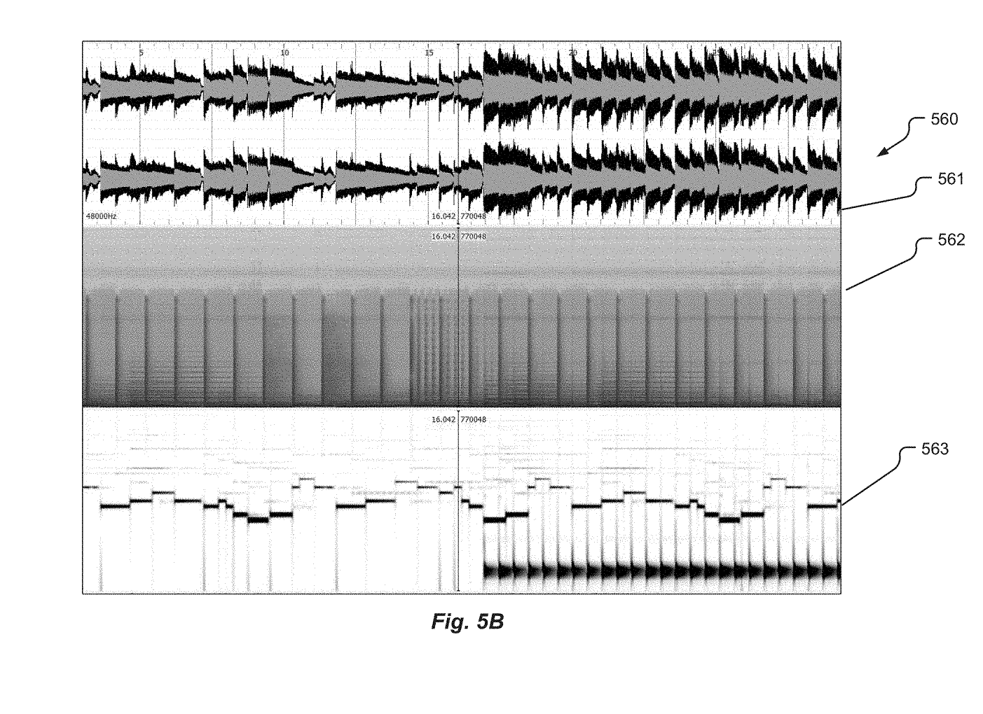

Other acoustic signal representations such as spectral contrast and music harmonics such as tonal centroid features (tonnetz) may be used in some embodiments. In some embodiments, whether the goal is to use a song to train a CNN or to use the CNN to analyze and categorize a song, the song may be transformed into a hyper-image such that it may be input into the CNN. In some embodiments, the transformations required to generate a hyper-image may be performed on a visual wave form version of a snippet of a song. In some embodiments, all the acoustic signal representations, e.g. chromagram, tempogram, mel-spectogram, MFCC, spectral contrast and tonnetz, may be combined into a normalized hyper-image, as shown in FIG. 5A, to feed into the deep neural network for training. This function may be performed by the music analysis system 300 using an aggregator 352. The hyper-image as generated by an aggregator 352 may be used as an input for the CNN 356. An alternative hyper-image 560 may in some embodiments be used as illustrated in FIG. 5B. Such a hyper-image 560 may comprise a two-channel waveform 561, a linear spectrogram 562, and/or a melodic range 563. The image representations 561, 562, and/or 563 may be stitched together to form a hyper-image to be used as an input to the CNN.

Architecture of the Convolutional Neural Network (CNN)

Convolutional neural networks (CNNs) may be similar to ordinary neural networks (NNs) in many ways. Like NNs, CNNs as used in certain embodiments described herein may be made up of neurons with learnable weights and biases. A neuron in the CNN may receive an input, perform a dot-product on the input, and follow it with a non-linearity. CNNs, unlike ordinary NNs, make an explicit assumption that the input is an image. In the present disclosure, the CNN may be enabled to explicitly assume that the input is a hyper-image.

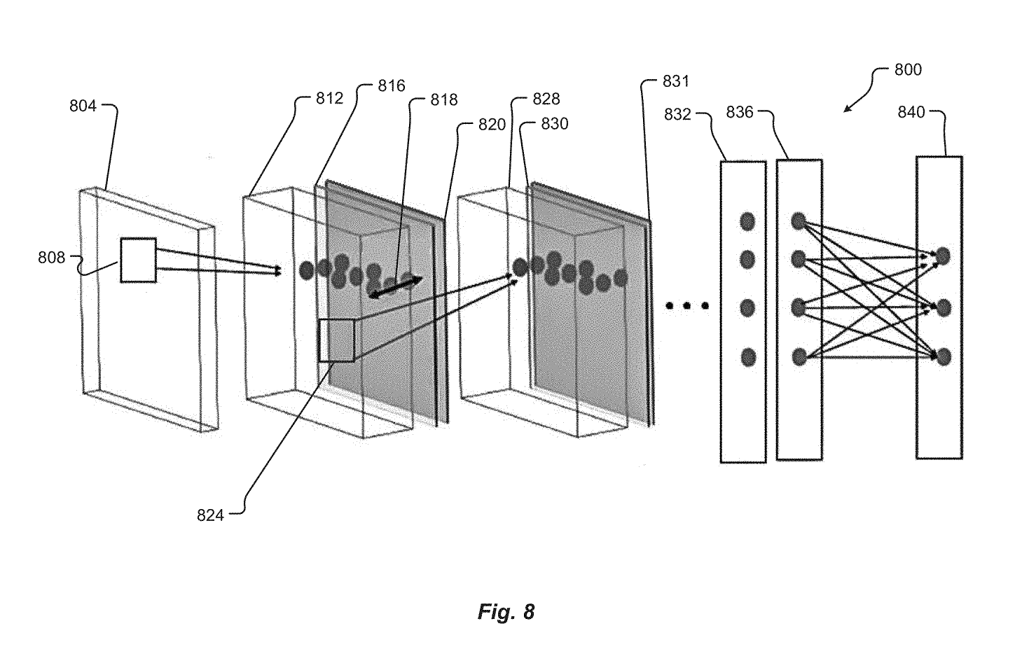

Various CNN architectures in terms of input layer dimension, convolutional layer, pooling layer, receptive filed of the neuron, filter depth, strides, as well as other implementation choices such as activation functions, local response normalization, etc. may be used in certain embodiments. An example CNN architecture is illustrated in FIG. 8. For example, in the embodiment shown in FIG. 8 a stochastic gradient decent (SGD) may be used to optimize for the weights in the CNN.

In certain embodiments, as described in FIG. 8, the CNN 800 may receive an input of an N×N audio hyper-image 804, wherein N is the number of pixels in each of the height and width of the hyper-image. In other embodiments, the input may be other rectangular shapes other than a square. The input image may be “padded”, i.e. a hyper-image with empty space, or zeros, surrounding the border. In certain embodiments this padding may be omitted, and thus the padding would be equal to zero. Following each convolutional layer, the receptive field 808 may be moved or convolved. For example, in FIG. 8, the receptive field 808 in the input layer 804 is slid to the receptive field 824 in the first convolutional layer 812. The amount of movement of the receptive fields between convolutional layers may be a number of pixels known as the stride. The number of convolutional layers used in a CNN in certain embodiments may be equal to (N−F+2P)/S+1, where N is the width (or height) of the input image, F is the width (or height) of the receptive field, S is the stride, and P is the amount of padding.

A first receptive field 808 of F by F pixels of the input layer 804 may be used for a first convolutional layer 812. The depth 818 of the first convolutional layer 812 may be any amount. In certain embodiments, the depth may be three pixels (Red, Green, Blue channels). Note that the word depth in this instance may refer to the third dimension of the convolutional layer 812, not the overall depth of a full neural network. Following the first convolutional layer 812, the CNN may pass the image through a response normalization layer 816, although in some embodiments a normalization layer may be omitted. Before proceeding to a second convolutional layer 828, the CNN 800 may comprise a max pooling layer 820. In some embodiments, any type of layer known in the art may be stacked into the CNN. For example, dilated convolutions, average pooling, L2-norm pooling, etc.

After the first convolutional layer 812 and any response normalization layer 816 and/or max pooling layer 820, a second convolutional layer 828 may be implemented operating on a second receptive field 824. The second convolutional layer 828 may be followed by one or more of a second response normalization layer 830 and/or a second max pooling layer 831. Other layers may in some embodiments be used following a second convolutional layer 828. The CNN may generate an output layer 840. The output layer may have a number of nodes which take inputs from the fully connected layer 836 and perform a computation.

Rectified linear units (ReLUs) may be used to activate neurons where non-saturating nonlinearity is supposed to run faster than the saturating ones. ReLUs may be non-linear operations with an output given by Output=Max(zero, Input). ReLU may be an element wise operation (applied per pixel). The purpose of ReLU may be to introduce non-linearity into the CNN. Local response normalization (LRN) may then be performed integrating over a filter or kernel map which fulfills a form of lateral constraint for big activities between neuron outputs computed using different kernel. Max pooling may be used to synchronize the outputs of neighboring groups of neurons in the same filter or kernel map. For example, a spatial neighborhood of pixels may be defined and the largest element from the rectified feature map within that window may be taken. A linear mapping may be used to generate the last two fully connected layers 832, 836. A softmax cross-entropy function may be used to build the overall loss function.

Music Embedding and Composing Music Using Trained Net

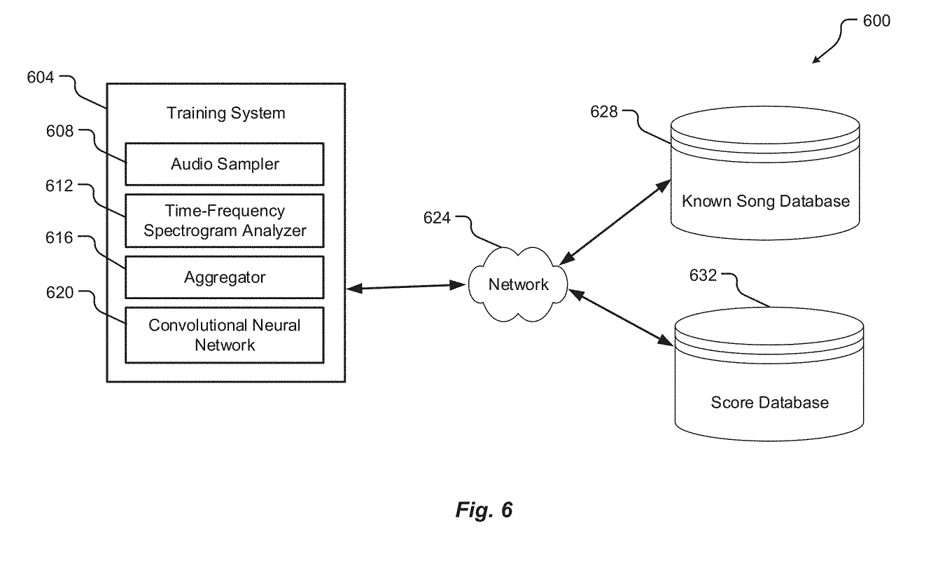

The values of the neurons on the last fully connected layer, just before the output layer, may be used to identify the latent embedding for each song. After a dimensionality reduction using PCA, in the 3D eigen-space, the distribution of song embedding may be visualized as shown in FIG. 6.

These latent vectors may be used to provide content features of each song, construct song-to-song similarity thus providing content-based recommendation. The trained weights of the neural network may also be used to compose a song, where music labels or characteristics are provided in advance, and we can perform backward propagation to artificially construct an audio hyper-image, and thus the auditory signals of song. Using Artificial Intelligence (AI) techniques to compose songs, and even lyrics, would be a promising application of this disclosure.

The neurons in the last fully connected layer may be used to embed all the songs, and these latent features can be fed to subsequent models such as collaborative filtering, a factorization machine, etc., to build a recommendation system. Further extensions of this work may be to use similar features and neural network models for voice or speech recognition, where the long-time scale of temporal structures of the auditory signals need to be captured perhaps by a recurrent neural network structure, with the intent of the speech as the latent state variable.

Training of the CNN

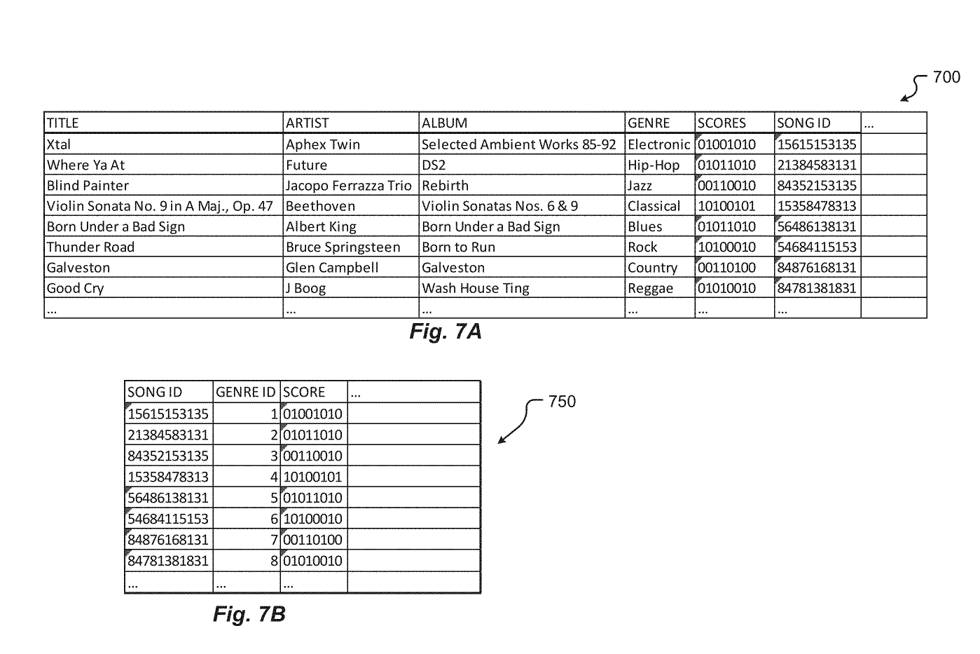

The training of the convolutional neural network may be implemented using backward propagation of errors as known in the art. In certain embodiments, training may use several Music Information Retrieval (MIR) benchmark dataset to train and test the deep learning model. The MIR benchmark datasets contain raw audio files of songs that are labeled either by genre or emotion. The music genre dataset contains 1886 songs all being encoded in mp3 format. The codec information such as sampling frequency and bitrate are 44,100 Hz and 128 kb, respectively. Databases as illustrated in FIGS. 7A and 7B may be generated based on the training of the CNN.

As illustrated in FIG. 7A, a database 700 may be generated listing tracks of audio and providing information such as in certain embodiments a track title, artist, album, genre, scores from the output of the CNN, and/or a song ID. In certain embodiments, a database may also list a number of track tags, such as tags for track emotion, track instruments, etc.

As illustrated in FIG. 7B, a database 750 may in certain embodiments be generated listing song IDs, genre IDs, and scores from the output of the CNN.

Training and Cross-Validation of the Model

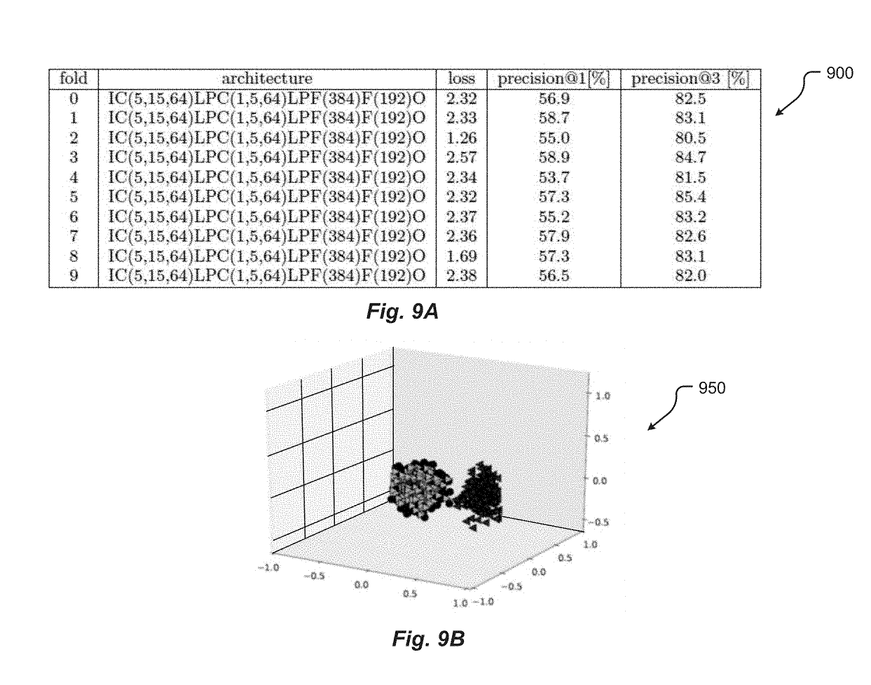

A 10-fold cross validation may be performed in terms of the predictions of music labels such as genres. For example, in certain embodiments, there may be nine genres in total, alternative, blues, electronic, folk/country, funk/soul/rnb, jazz, pop, rap/hip-hop and rock, in the MIR dataset. Precisions of the predicted music label at rank 1 and 3 in certain embodiments are shown in FIG. 9A, in which the network architecture follows the notation of I for input layer, C for convolutional layer with stride, receptive field and filter depth, L for local response normalization layer, P for max pooling layer, F for fully connected layer with number of fully connected neurons, and O for the output layer. To split the training and testing, in certain embodiments random snippets may be selected across all songs in a database for both training and testing samples. In other embodiments, snippets may be selected as evenly ordered by the song title to make sure the snippets from the same song do not enter both training and testing sample simultaneously. Both methods of splitting the dataset give similar cross validation results.

In certain embodiments, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

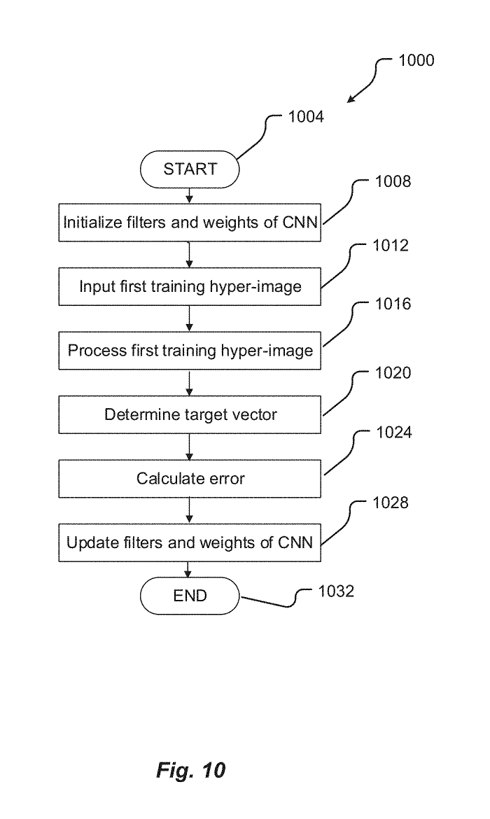

The training of the CNN may be implemented using backpropagation. For example, all filters and parameters and/or weights may be initialized with random values. A training hyper-image may be inputted into the CNN. A separate set of filters and parameters and/or weights may be used for determining each of a genre, an emotion, or other sets of song tags. An example method 1000 of training a CNN for use with certain embodiments is illustrated in FIG. 10. The method 1000 may begin at step 1004 and proceed to 1008 in which the filters and weights of the CNN may be initialized with random values. In the initial stage, any values may be used for the weights of the CNN. As more and more training hyper-images are processed by the CNN, the values of the weights may become optimized.

At step 1012, a first training hyper-image may be input into the CNN. Each training hyper-image may be stored in and retrieved from a network-connected database. In certain embodiments, the training hyper-images may be stored along with one or more tags describing the song associated with the training hyper-image. For example, a hyper-image generated from a jazz song may be stored with a tag of “jazz”. In some embodiments, the training hyper-images may be associated with a number of tags describing features of the songs such as genre, emotion, instruments, etc.

At step 1016, the CNN may process the first training hyper-image and output a score vector. In step 1020, the method may comprise determining a target vector based on one or more tags associated with the first training hyper-image. For example, the CNN may be implemented in order to determine a genre of the inputted hyper-image. In order to determine the target vector, the method may comprise determine a genre tag associated with the inputted hyper-image. The genre tag associated with the inputted hyper-image may be used by a computer performing the training to determine the target vector.

In step 1024, the method may comprise calculating an error. The error may be calculated by summing one-half the square of the target probability minus the output probability. The following formula may be used: Σ½(Target Probability−Output Probability). In step 1028, using backpropagation, the gradients of the error may be calculated and gradient descent may be used to update filter values to optimize output error. In step 1032, the method 1000 may end. The method 1000 may repeat for each training hyper-image until the filter values are optimized.

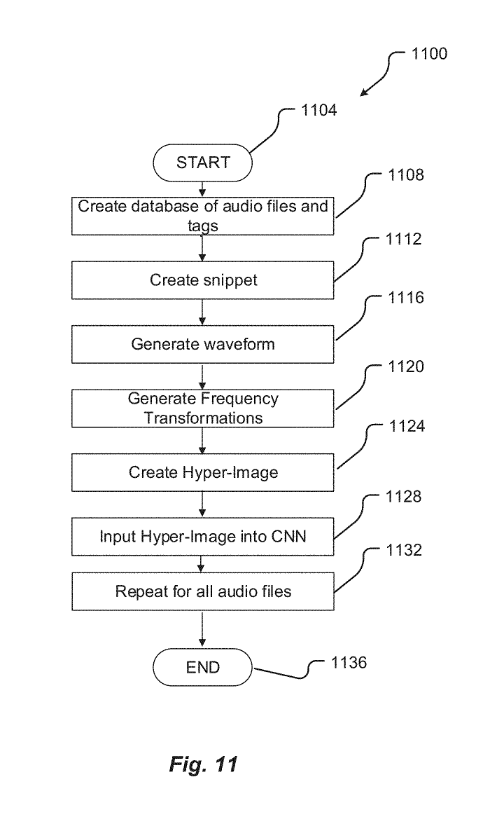

An exemplary method 1100 of generating hyper-images is illustrated in FIG. 11. The method 1100 may begin at step 1104. In step 1108, the method may comprise creating a database of audio files and associated tags. For example, the audio files may be stored along with tags as metadata describing the tagged audio. In certain embodiments, the tags list a genre describing the tagged audio. In some embodiments the tags may list an emotion or instrument or other feature of a song for each audio file.

At step 1112, the method may comprise creating a snippet for a first one of the audio files. At step 1116, the method may comprise converting the snippet for the first one of the audio files to a waveform visualization of the snippet. The waveform visualization may be an image file. At step 1120, the method may comprise generating a number of frequency transformations as described herein for the snippet. The frequency transformations may be as described in more detail above and as illustrated in FIG. 4B. The frequency transformations may be a number of image files created from the waveform visualization of the snippet. After generating the multiple frequency transformations from the snippet waveform image, the method may proceed to step 1124 in which a hyper-image may be created. The hyper-image created in step 1124 may be an aggregation of the multiple frequency transformations as illustrated in FIG. 5A. For example, the hyper-image may be created by stitching together the image files of the frequency transformations into the hyper-image.

After generating the hyper-image in step 1124, the method may proceed with step 1128 in which the hyper-image may be inputted into a CNN for training or may be stored in a database for later use. At step 1132, the method may return to step 1108 and repeat the steps with a second audio file in the database. The method 1100 may repeat until a hyper-image has been generated for all audio files in the database. The method may end at step 1136.

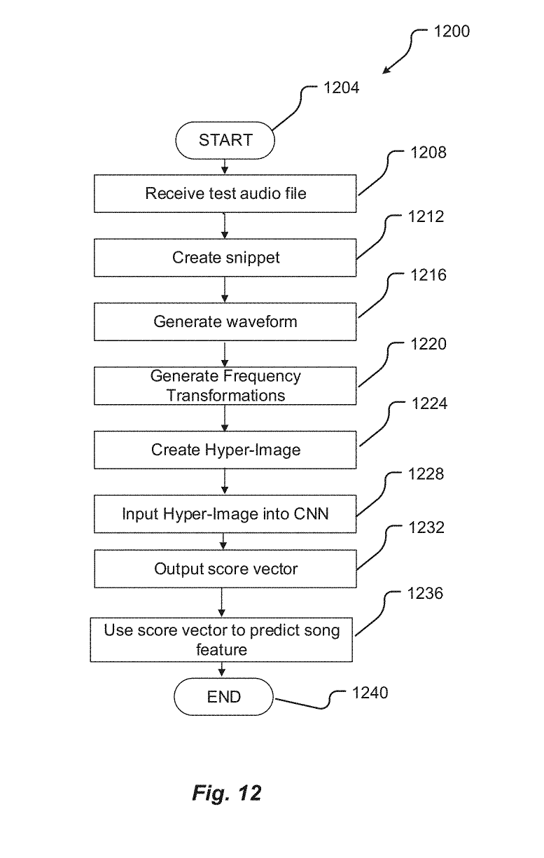

A method 1200 for analyzing songs using a trained CNN is illustrated in FIG. 12. The method 1200 may begin at step 1204 and proceed to step 1208 in which a first song or audio file is received. At step 1212 a snippet may be created from the received song or audio. At step 1216 the snippet may be used to create a visual waveform image. At step 1220 the waveform may be used to create a number of frequency transformation images based on the waveform. At 1224 the frequency transformation images may be stitched together into a hyper-image. At step 1228 the hyper-image may be inputted into a trained CNN. At step 1232 the CNN may output a score vector. At step 1236 the score vector may be used to predict a genre, or emotion, or other feature of the received audio.

Any of the steps, functions, and operations discussed herein can be performed continuously and automatically.

The exemplary systems and methods of this disclosure have been described in relation to a computer system. However, to avoid unnecessarily obscuring the present disclosure, the preceding description omits a number of known structures and devices. This omission is not to be construed as a limitation of the scope of the claimed disclosure. Specific details are set forth to provide an understanding of the present disclosure. It should, however, be appreciated that the present disclosure may be practiced in a variety of ways beyond the specific detail set forth herein.

Furthermore, while the exemplary embodiments illustrated herein show the various components of the system collocated, certain components of the system can be located remotely, at distant portions of a distributed network, such as a LAN and/or the Internet, or within a dedicated system. Thus, it should be appreciated, that the components of the system can be combined into one or more devices, such as a server, communication device, or collocated on a particular node of a distributed network, such as an analog and/or digital telecommunications network, a packet-switched network, or a circuit-switched network. It will be appreciated from the preceding description, and for reasons of computational efficiency, that the components of the system can be arranged at any location within a distributed network of components without affecting the operation of the system.

Furthermore, it should be appreciated that the various links connecting the elements can be wired or wireless links, or any combination thereof, or any other known or later developed element(s) that is capable of supplying and/or communicating data to and from the connected elements. These wired or wireless links can also be secure links and may be capable of communicating encrypted information. Transmission media used as links, for example, can be any suitable carrier for electrical signals, including coaxial cables, copper wire, and fiber optics, and may take the form of acoustic or light waves, such as those generated during radio-wave and infra-red data communications.

While the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the systems and methods of this disclosure can be implemented in conjunction with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device or gate array such as PLD, PLA, FPGA, PAL, special purpose computer, any comparable means, or the like. In general, any device(s) or means capable of implementing the methodology illustrated herein can be used to implement the various aspects of this disclosure. Exemplary hardware that can be used for the present disclosure includes computers, handheld devices, telephones (e.g., cellular, Internet enabled, digital, analog, hybrids, and others), and other hardware known in the art. Some of these devices include processors (e.g., a single or multiple microprocessors), memory, nonvolatile storage, input devices, and output devices. Furthermore, alternative software implementations including, but not limited to, distributed processing or component/object distributed processing, parallel processing, or virtual machine processing can also be constructed to implement the methods described herein.

In yet another embodiment, the disclosed methods may be readily implemented in conjunction with software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this disclosure is dependent on the speed and/or efficiency requirements of the system, the particular function, and the particular software or hardware systems or microprocessor or microcomputer systems being utilized.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as a program embedded on a personal computer such as an applet, JAVA® or CGI script, as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the embodiments with reference to particular standards and protocols, the disclosure is not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various embodiments, configurations, and aspects, includes components, methods, processes, systems and/or apparatus substantially as depicted and described herein, including various embodiments, subcombinations, and subsets thereof. Those of skill in the art will understand how to make and use the systems and methods disclosed herein after understanding the present disclosure. The present disclosure, in various embodiments, configurations, and aspects, includes providing devices and processes in the absence of items not depicted and/or described herein or in various embodiments, configurations, or aspects hereof, including in the absence of such items as may have been used in previous devices or processes, e.g., for improving performance, achieving ease, and/or reducing cost of implementation.

The foregoing discussion of the disclosure has been presented for purposes of illustration and description. The foregoing is not intended to limit the disclosure to the form or forms disclosed herein. In the foregoing Detailed Description for example, various features of the disclosure are grouped together in one or more embodiments, configurations, or aspects for the purpose of streamlining the disclosure. The features of the embodiments, configurations, or aspects of the disclosure may be combined in alternate embodiments, configurations, or aspects other than those discussed above. This method of disclosure is not to be interpreted as reflecting an intention that the claimed disclosure requires more features than are expressly recited in each claim. Rather, as the following claims reflect, inventive aspects lie in less than all features of a single foregoing disclosed embodiment, configuration, or aspect. Thus, the following claims are hereby incorporated into this Detailed Description, with each claim standing on its own as a separate preferred embodiment of the disclosure.

Moreover, though the description of the disclosure has included description of one or more embodiments, configurations, or aspects and certain variations and modifications, other variations, combinations, and modifications are within the scope of the disclosure, e.g., as may be within the skill and knowledge of those in the art, after understanding the present disclosure. It is intended to obtain rights, which include alternative embodiments, configurations, or aspects to the extent permitted, including alternate, interchangeable and/or equivalent structures, functions, ranges, or steps to those claimed, whether or not such alternate, interchangeable and/or equivalent structures, functions, ranges, or steps are disclosed herein, and without intending to publicly dedicate any patentable subject matter.

Embodiments include a method of estimating song features, the method comprising: an audio receiver receiving a first training audio file; generating, with one or more processors, a first waveform associated with the first training audio file; generating, with the one or more processors, one or more frequency transformations from the first waveform; generating, with the one or more processors, a hyper-image from the one or more frequency transformations; processing, with a convolutional neural network, the hyper-image; estimating, with the one or more processors, an error in an output of the convolutional neural network; optimizing, with the one or more processors, one or more weights associated with the convolutional neural network based on the estimated error; and using the convolutional neural network to estimate a feature of a testing audio file.

Aspects of the above method include wherein the one or more frequency transformations include one or more of a linear-frequency power spectrum, a log-frequency power spectrum, a constant-Q power spectrum, a chromogram, a tempogram, an MFL-spectogram, and an MFCC.

Aspects of the above method include wherein the one or more weights associated with the convolutional neural network are further optimized with a second training audio file.

Aspects of the above method include wherein the error is estimated based on one or more tags associated with the first training audio file.

Aspects of the above method include wherein the one or more tags include a tag labeling a genre of the first training audio file.

Aspects of the above method include wherein the first waveform is a visualization of a snippet of the first training audio file.

Aspects of the above method include wherein the feature of the first testing audio file is one or more of a genre, an emotion, and an instrument associated with the testing audio file.

Embodiments include a system, comprising: a processor; and a computer-readable storage medium storing computer-readable instructions, which when executed by the processor, cause the processor to perform: generating a first waveform associated with a first training audio file; generating one or more frequency transformations from the first waveform; generating a hyper-image from the one or more frequency transformations; processing, with a convolutional neural network, the hyper-image; estimating an error in an output of the convolutional neural network; optimizing one or more weights associated with the convolutional neural network based on the estimated error; and using the convolutional neural network to estimate a feature of a testing audio file.

Aspects of the above system include wherein the one or more frequency transformations include one or more of a linear-frequency power spectrum, a log-frequency power spectrum, a constant-Q power spectrum, a chromogram, a tempogram, an MFL-spectogram, and an MFCC.

Aspects of the above system include wherein the one or more weights associated with the convolutional neural network are further optimized with a second training audio file.

Aspects of the above system include wherein the error is estimated based on one or more tags associated with the first training audio file.

Aspects of the above system include wherein the one or more tags include a tag labeling a genre of the first training audio file.

Aspects of the above system include wherein the first waveform is a visualization of a snippet of the first training audio file.

Aspects of the above system include wherein the feature of the first testing audio file is one or more of a genre, an emotion, and an instrument associated with the testing audio file.

Embodiments include a computer program product, comprising: a non-transitory computer readable storage medium having computer readable program code embodied therewith, the computer readable program code comprising: computer readable program code configured when executed by a processor to: generate a first waveform associated with a first training audio file; generate one or more frequency transformations from the first waveform; generate a hyper-image from the one or more frequency transformations; process, with a convolutional neural network, the hyper-image; estimate an error in an output of the convolutional neural network; optimize one or more weights associated with the convolutional neural network based on the estimated error; and use the convolutional neural network to estimate a feature of a testing audio file.

Aspects of the above computer program product include wherein the one or more frequency transformations include one or more of a linear-frequency power spectrum, a log-frequency power spectrum, a constant-Q power spectrum, a chromogram, a tempogram, an MFL-spectogram, and an MFCC.

Aspects of the above computer program product include wherein the one or more weights associated with the convolutional neural network are further optimized with a second training audio file.

Aspects of the above computer program product include wherein the error is estimated based on one or more tags associated with the first training audio file.

Aspects of the above computer program product include wherein the one or more tags include a tag labeling a genre of the first training audio file.

Aspects of the above computer program product include wherein the first waveform is a visualization of a snippet of the first training audio file.

Aspects of the above computer program product include wherein the feature of the first testing audio file is one or more of a genre, an emotion, and an instrument associated with the testing audio file.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation. Human input is deemed to be material if such input influences how the process or operation will be performed. Human input that consents to the performance of the process or operation is not deemed to be “material.”

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

What is claimed is:

1. A method of estimating song features, the method comprising:
an audio receiver receiving a first training audio file;
generating, with one or more processors, a first waveform associated with the first training audio file;
generating, with the one or more processors, one or more frequency transformations from the first waveform;
generating, with the one or more processors, a hyper-image from the one or more frequency transformations;
processing, with a convolutional neural network, the hyper-image;
estimating, with the one or more processors, an error in an output of the convolutional neural network;
optimizing, with the one or more processors, one or more weights associated with the convolutional neural network based on the estimated error; and
using the convolutional neural network to estimate a feature of a testing audio file.

2. The method of claim 1, wherein the one or more frequency transformations include one or more of a linear-frequency power spectrum, a log-frequency power spectrum, a constant-Q power spectrum, a chromogram, a tempogram, an MFL-spectogram, and an MFCC.

3. The method of claim 1, wherein the one or more weights associated with the convolutional neural network are further optimized with a second training audio file.

4. The method of claim 1, wherein the error is estimated based on one or more tags associated with the first training audio file.

5. The method of claim 4, wherein the one or more tags include a tag labeling a genre of the first training audio file.

6. The method of claim 1, wherein the first waveform is a visualization of a snippet of the first training audio file.

7. The method of claim 1, wherein the feature of the first testing audio file is one or more of a genre, an emotion, and an instrument associated with the testing audio file.

8. A system, comprising:
a processor; and
a computer-readable storage medium storing computer-readable instructions, which when executed by the processor, cause the processor to perform:
generating a first waveform associated with a first training audio file;
generating one or more frequency transformations from the first waveform;
generating a hyper-image from the one or more frequency transformations;
processing, with a convolutional neural network, the hyper-image;
estimating an error in an output of the convolutional neural network;
optimizing one or more weights associated with the convolutional neural network based on the estimated error; and
using the convolutional neural network to estimate a feature of a testing audio file.

9. The system of claim 8, wherein the one or more frequency transformations include one or more of a linear-frequency power spectrum, a log-frequency power spectrum, a constant-Q power spectrum, a chromogram, a tempogram, an MFL-spectogram, and an MFCC.

10. The system, wherein the one or more weights associated with the convolutional neural network are further optimized with a second training audio file.

11. The system, wherein the error is estimated based on one or more tags associated with the first training audio file.

12. The system of claim 11, wherein the one or more tags include a tag labeling a genre of the first training audio file.

13. The system of claim 8, wherein the first waveform is a visualization of a snippet of the first training audio file.

14. The system of claim 8, wherein the feature of the first testing audio file is one or more of a genre, an emotion, and an instrument associated with the testing audio file.

15. A computer program product, comprising:
a non-transitory computer readable storage medium having computer readable program code embodied therewith, the computer readable program code comprising:
computer readable program code configured when executed by a processor to:
generate a first waveform associated with a first training audio file;
generate one or more frequency transformations from the first waveform;
generate a hyper-image from the one or more frequency transformations;
process, with a convolutional neural network, the hyper-image;
estimate an error in an output of the convolutional neural network;
optimize one or more weights associated with the convolutional neural network based on the estimated error; and
use the convolutional neural network to estimate a feature of a testing audio file.

16. The computer program product of claim 15, wherein the one or more frequency transformations include one or more of a linear-frequency power spectrum, a log-frequency power spectrum, a constant-Q power spectrum, a chromogram, a tempogram, an MFL-spectogram, and an MFCC.

17. The computer program product of claim 15, wherein the one or more weights associated with the convolutional neural network are further optimized with a second training audio file.

18. The computer program product of claim 15, wherein the error is estimated based on one or more tags associated with the first training audio file.

19. The computer program product of claim 18, wherein the one or more tags include a tag labeling a genre of the first training audio file.

20. The computer program product of claim 15, wherein the first waveform is a visualization of a snippet of the first training audio file.
